(19) United States
(12) Patent Application Publication
(10) Pub. No.: US 2019/0236154 A1
(43) Pub. Date: Aug. 1, 2019

(54) CLIENT SIDE QUERY MODEL EXTENSIBILITY FRAMEWORK

(71) Applicant: VMware, Inc., Palo Alto, CA (US)

(72) Inventors: Kostadin GEORGIEV, Sofia (BG); Murad MURAD, Sofia (BG); Deyan POPOV, Sofia (BG); Grigor HARBALIEV, Sofia (BG); Lyubomir TZVETKOV, Sofia (BG)

(21) Appl. No.: 15/880,774

(22) Filed: Jan. 26, 2018

(51) Int. Cl. G06F 17/30; G06F 9/455; G06F 17/27

(52) U.S. Cl. CPC G06F 17/3043; G06F 17/30864; G06F 2009/45595; G06F 17/2705; G06F 9/45558

(57) ABSTRACT

One or more embodiments provide techniques for querying a database having information contained therein that is associated with one or more virtual machines executing on a host. A management agent receives a query in a first format from a user device, wherein the first format is not executable in the database. The management agent parses the query to identify one or more commands in the query. The management agent translates the query into a modified query that is executable in the database. The management agent references one or more pre-loaded properties associated with the database. The management agent executes the translated query against the database. The management agent returns results of the execution.

### BACKGROUND

Computer virtualization is a technique that involves encapsulating a physical computing machine platform into virtual machine(s) executing under control of virtualization software on a hardware computing platform or “host.” A virtual machine provides virtual hardware abstractions for processor, memory, storage, and the like to a guest operating system. The virtualization software, also referred to as a “hypervisor,” includes one or more virtual machine monitors (VMMs) to provide execution environment(s) for the virtual machine(s). As physical hosts have grown larger, with greater processor core counts and terabyte memory sizes, virtualization has become key to the economic utilization of available hardware.

Cloud architectures are used in cloud computing and cloud storage systems for offering infrastructure-as-a-service (IaaS) cloud services. Examples of cloud architectures include the VMware vCloud Director® cloud architecture software, Amazon EC2™ web service, and OpenStack™ open source cloud computing service. IaaS cloud service is a type of cloud service that provides access to physical and/or virtual resources in a cloud environment. These services provide a tenant application programming interface (API) that supports operations for manipulating IaaS constructs, such as virtual machines (VMs) and logical networks.

### SUMMARY

One or more embodiments provide techniques for querying a database having information contained therein that is associated with one or more virtual machines executing on a host. A management agent receives a query in a first format from a user device, wherein the first format is not executable in the database. The management agent parses the query to identify one or more commands in the query. The management agent translates the query into a modified query that is executable in the database. The management agent references one or more pre-loaded properties associated with the database. The management agent executes the translated query against the database. The management agent returns results of the execution.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of an example virtualized computing, according to one embodiment disclosed herein.

FIG. 2 is a logical diagram illustrating a virtualized computing environment, according to an embodiment.

FIG. 3 is a flow diagram illustrating a method of querying a database, according to an embodiment.

FIG. 4 is a logical flow diagram, illustrating an incoming, simple query and an outgoing, modified query, according to one embodiment.

FIG. 5 is a logical flow diagram, illustrating an incoming, simple query and an outgoing, modified query, according to one embodiment.

FIG. 6 is a logical flow diagram, illustrating an incoming, simple query and an outgoing, modified query, according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

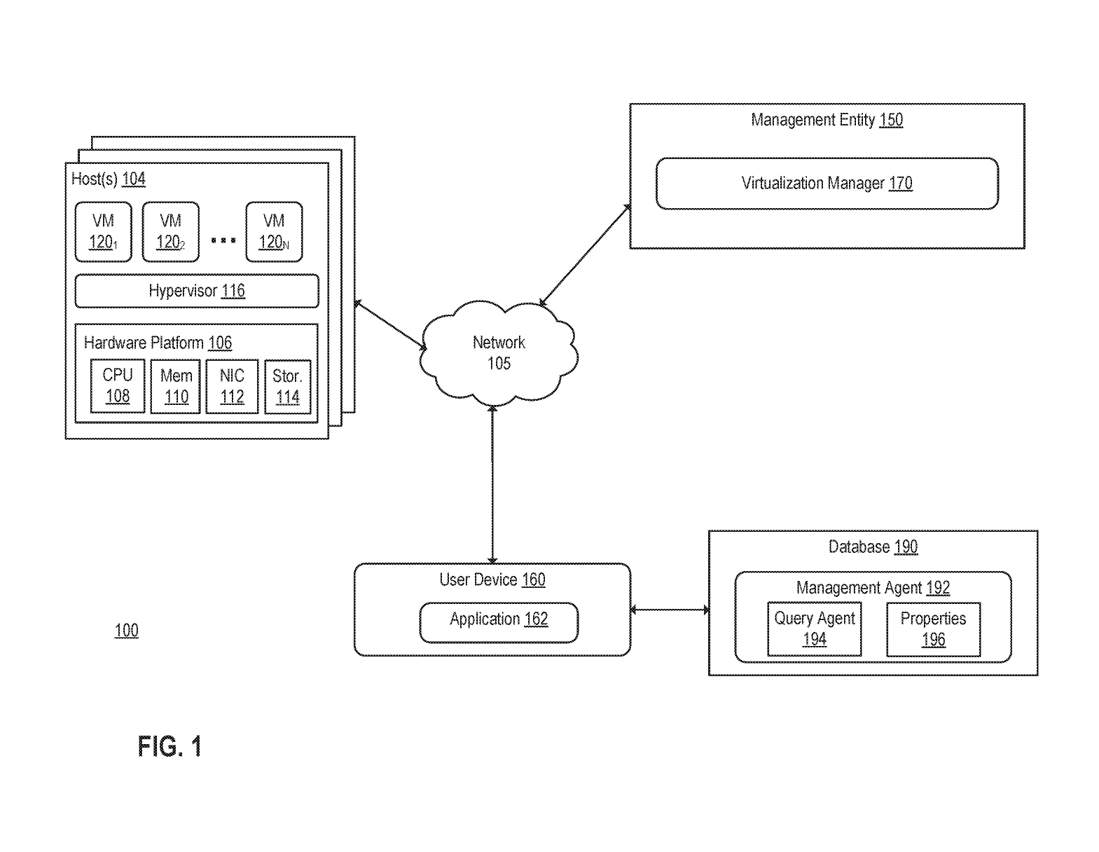

FIG. 1 is a schematic diagram illustrating an example virtualized computing environment 100. Although an example is shown, it should be understood that sample virtualized computing environments 100 may include additional or alternative components, and may have a different configuration. In a virtualized computing environment, such as virtualized computing environment 100, users may manage, monitor, and administer various objects (e.g., hosts, virtual machines, storage resources, etc.) using a web client (e.g., web client 162).

Virtualized computing environment 100 includes one or more host computer systems (“host 104”). Hosts 104 may be constructed on a server grade platform 106, such as an x86 architecture platform. As shown, hardware platform 106 of each host 104 may include conventional components of a computing device, such as one or more processors (CPUs) 108, system memory 110, a network interface 112, a storage system 114, and other I/O devices, such as, for example, a mouse and keyboard (not shown). CPU 108 is configured to execute instructions, for example, executable instructions that perform one or more operations described herein and may be stored in memory 110 an in local storage. Memory 110 is a device allowing information, such as executable instructions, cryptographic keys, virtual disks, configurations, and other data to be stored and retrieved. Memory 110 may include, for example, one or more random access memory (RAM) modules. Network interface 112 may be one or more network adapters, also referred to as Network Interface Card (NIC). Storage system 114 represents local storage (e.g., one or more hard disks, flash memory modules, solid state disks, and optical disks) and/or a storage interface that enables host 104 to communicate with one or more network data storage systems. Examples of a storage interface are a host bus adapter (HBA) that couples host 104 to one or more storage arrays, such as a storage area network (SAN) or a network-attached storage (NAS), as well as other network data storage systems.

Each host 104 is configured to provide a virtualization layer that abstracts processor, memory, storage, and networking resources of hardware platform 106 into multiple virtual machines 120₁ to 120_{N} (collectively referred to as VMs 120) that run concurrently on the same hosts. VMs 120 run on top of a software interface layer, referred to herein as a hypervisor 116 that enables sharing of the hardware resources of host 104 by VMs 120. One example of the hypervisor 116 that may be used in an embodiment described herein is a VMware ESXi™ hypervisor provided as part of the VMware vSphere® solution made commercially available from VMware, Inc., of Palo Alto, Calif. Hypervisor 116 may run on top of the operating system of host 104 or directly on hardware components of host 104.

Virtualized computing environment 100 may further include management entity 150, which is accessible by user devices 160 to manage various objects (e.g., hosts 104, VMs 120, storage systems 114, etc.). Management entity 150 generally provides various objects for any suitable purpose, such as deployment, provisioning, lifecycle management, maintenance, and the like. In practice, management entity 150 may be implemented using a virtual machine.

A user may operate user device 160 to access a functionality of management entity 150 using an application 162, such as VMware vSphere® web client. Application 162 may be any suitable browser-based application such as based on any suitable architecture supported by management entity 150.

An example architecture may include a user interface layer with an application that displays user interface element with which users interact (e.g., menus, navigation elements, etc.). A service layer of the example architecture may facilitate various services. User devices 160 may be operated by any suitable users, such as system administrators, organization administrators, database users, application developers, system architects, etc. Any suitable computing device may be used as user device 160, such as desktop computer, mobile device, tablet computer, and personal digital assistant, etc. The user interface of application 162 may further provide the user with a native look-and-feel of the management console of management entity 150, thereby allowing user device 106 to use the same interface.

Management entity 150 may further include a virtualization manager 170. Virtualization manager 170 is an application that executes within the management entity 150, which provides an interface to hardware platform 106. Virtualization manager 170 is configured to carry out various tasks to manage virtual computing resources provided by cloud computing system 100. One example of a virtualization manager that can be adapted according to embodiments described herein is the vCenter Server™ product made available from VMware, Inc. For example, virtualization manager 170 can deploy virtual machines (VMs) in cloud computing system 100 or perform other administrative tasks with respect to VMs in cloud computing system 100 using an application programming interface (API) published by cloud computing system 100, such as a representational state transfer (REST) API or any other client-server communication protocol.

Virtualized computing environment 100 may further include a database 190 in communication with user device 160. Database 190 includes data associated with each VM 120 executing on one or more host(s) 104 associated with the user of user device 160. For example, database 190 may include information associated with [INSERT HERE]. In some virtualized computing environments 100, to access information in database 190, an end user of user device 160 would query database 190. An extension is a custom property file that was not available a data source of database 190, but was defined in terms of real properties. For example, custom property “VirtualMachine/hostname” can be described as the “name” property of HostSystem object referenced by the “VirtualMachine/runtime/host” property. Each custom property was defined by an XML snippet plugged into DataService. The XML snippet forced users to query database 190 using an XML format. Additionally, the XML snippets resulted in performance penalties due to the size of the XML files.

To combat the above, database 190 includes a management entity 190. Management entity 190 aids in providing a data retrieval extensibility framework that allows client developers to improve the data model of database 190 to appear as if database 190 was designed to match the query patterns of the client. This is achieved, in part, by replacing the XML snippets of some techniques with Java® annotations, which provides a domain service language that extends existing resource models in a descriptive way.

Management entity 192 includes properties 194 and query agent 196. Properties 194 allow clients to query database 190 as if properties 194 were native database-side properties in all clauses of the queries. Examples of properties 194 are “related property,” “derived property,” and “predicate property.”

A related property is a client-side query model property that is mapped to an existing property value that is provided by a related resource model. In other words, a related property is a basic primitive that allows for projecting related resource model properties into a client-side resource model. The related property defines one or more multiple relationship traversals that need to be made in order to reach the resource model which provides the property to which the custom property value is mapped.

A derived property is a user-defined property which is computed (derived) as a function over existing properties of a given resource property. A derived property may be used only in the SELECT clause of a query.

A predicate property is a Boolean-valued property, the value of which is derived as a predicate function over existing properties of a given resource model. The predicate property may be used in the WHERE clause of a query in addition to the SELECT clause of the query. The predicate property cannot, however, be used in the ORDER clause of the query.

Query agent 196 is configured to receive a query from the client via user device 160. For example, query agent 196 receives a queries in the form of SELECT, WHERE, and ORDER BY from client via user device 160. Query agent 196 is configured to translate the queries received from user device into a query form that is usable by database 190. For example, query agent 196 allows users of user device 160 to enter a simple query, and then subsequently translates the simple query into a more complex query compatible with database 190.

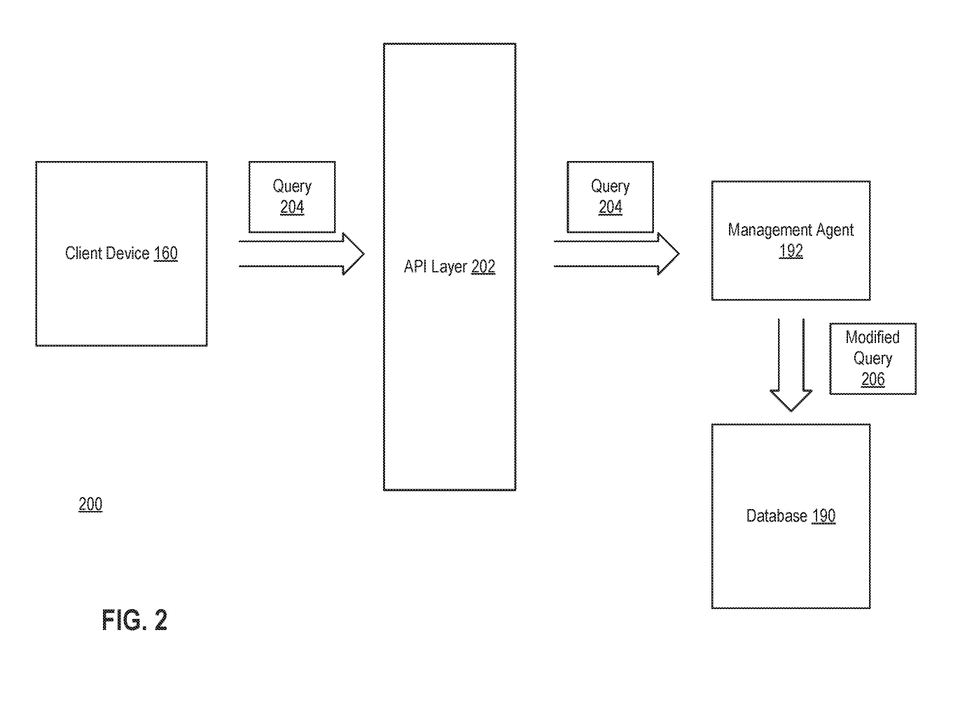

FIG. 2 is a logical diagram 200 illustrating a virtualized computing environment 200, according to an embodiment. As shown, virtualized computing environment 200 includes user device 160 and database 190 separated by graphical user interface (GUI) 202. GUI 202 presents the user of user device 160 with an interface receptive of a simplified query. For example, GUI 202 presents the user with an interface receptive of queries in the form of SELECT, WHERE, ORDER BY, and the like. GUI 202 effectively “shields” the user from the underlying query requirements of database 190.

Between GUI 202 and database 190 is management entity 192. Management entity 192 receives the simplified query and converts the simplified query into a query compatible with database 190. For example, query agent 196 parses the simplified query and converts the query into a syntax that is readable by database 190. Query agent 196 leverages properties 194 to convert the simplified query into the modified query. Management Agent 192 subsequently transmits modified query to database 190.

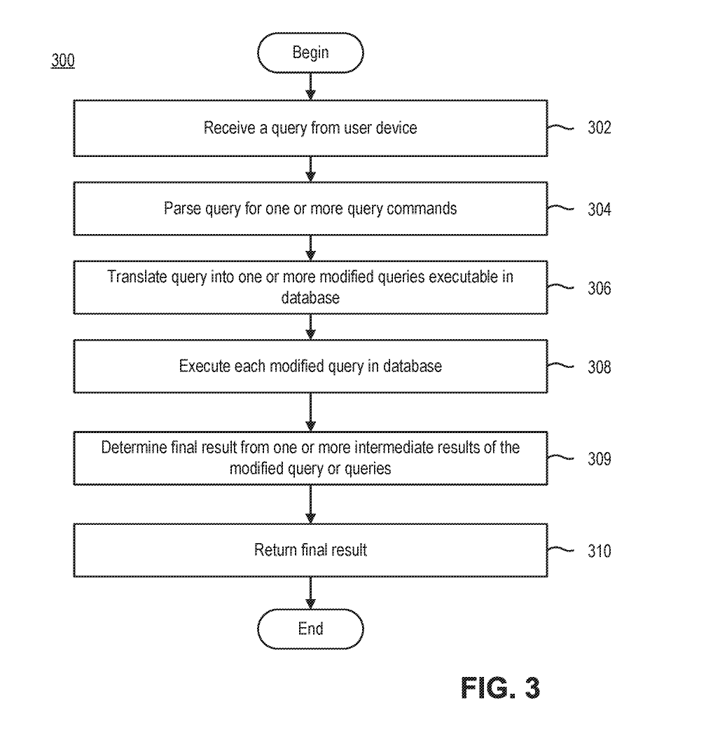

FIG. 3 is a flow diagram illustrating a method 300 of querying a database, according to an embodiment. Method 300 begins at step 302. At step 302, management entity 192 receives a query from user device 160. For example, management entity 192 receives a simplified query from user device 160. The simplified query was generated by the user via GUI 202.

At step 304, query agent 194 parses simplified query for one or more query commands. For example, query agent 194 parses simplified query for commands such as SELECT, WHERE, ORDER BY, or any other SQL programming language command. Generally, query agent 194 parses simplified query for commands associated with the “snippets” that were added to database 190. For example, if snippets that were added to database 190 were Python based, query agent 194 would parse the simplified query for Python commands.

At step 306, query agent 194 translates the simplified query into one or more modified queries each of which is executable by database 190. For example, a modified query is a query that is generated in a syntax that is executable by database 190. Query agent 194 reference properties 196 stored in database to translate the parsed query commands. For example, query agent 194 may reference one or more of related property, derived property, or predicate property in translating the simplified query into one or more modified queries. Such configuration allows virtualized computing environment to keep the basic query API simple while interpreting the domain service language on top of the query API.

At step 308, query agent 194 submits the modified query or queries to database 190. In other words, management agent 192 queries database 190 using the modified query or queries. Each modified query is compatible with the programming language of database 190. At step 309, management agent determines a final result from one or more intermediate results of the modified query or queries. At step 310, management entity 194 returns the final result to the user device 160. It is to be understood that method 300 can be repeated for each query received from the user device.

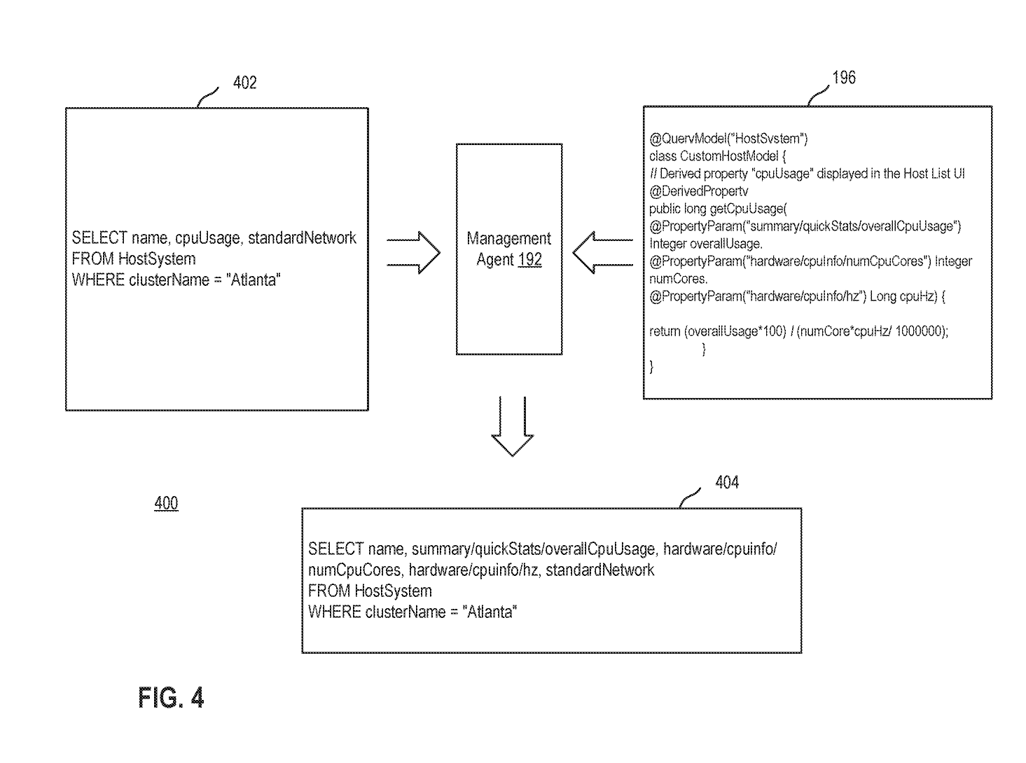

FIG. 4 is a logical flow diagram 400, illustrating an incoming, simple query 402 and an outgoing, modified query 404, according to one embodiment. As shown, positioned between simple query 402 and modified query 404 is management agent 192. The simply query 402 includes the SQL command SELECT. Management agent 192 uses derived property of properties 196 to translate simple query 402 to modified query 404.

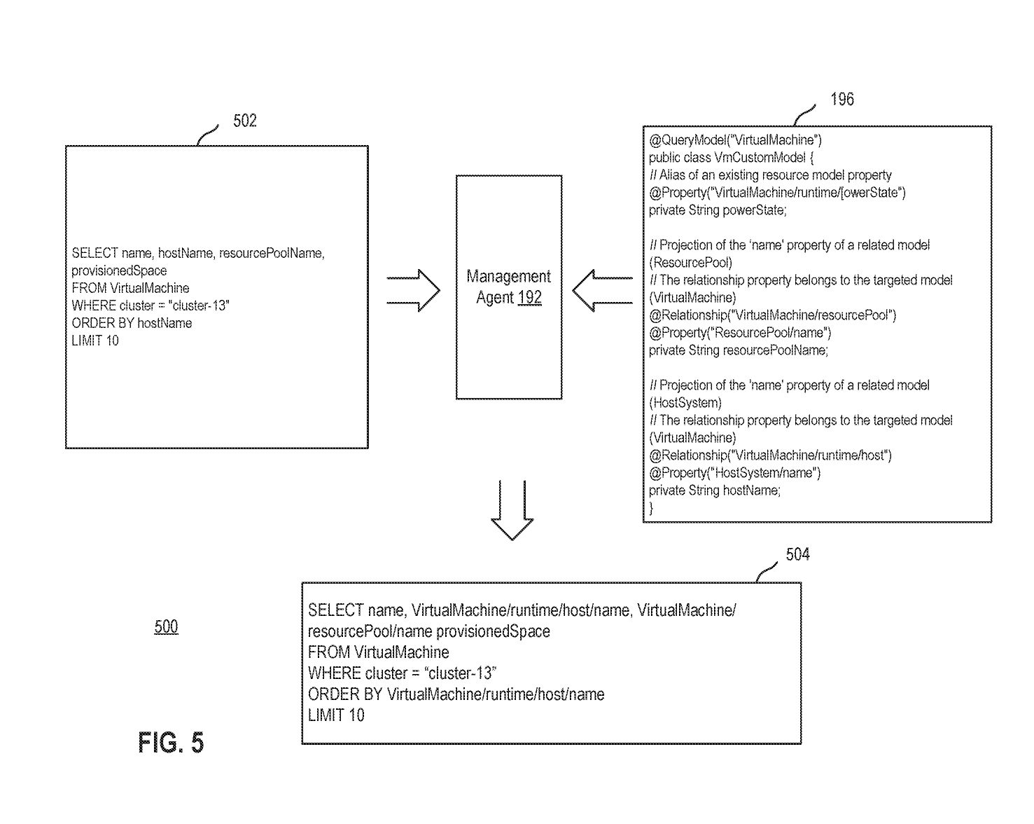

FIG. 5 is a logical flow diagram 500, illustrating an incoming, simple query 502 and an outgoing, modified queries 504, 505, and 506, according to one embodiment. As shown, positioned between simple query 502 and modified queries 504-506 is management agent 192. The simply query 502 includes the SQL command SELECT. Management agent 192 denormalizes statements in simple query 502 using properties 196 to translate simple query 502 to modified queries 504-506.

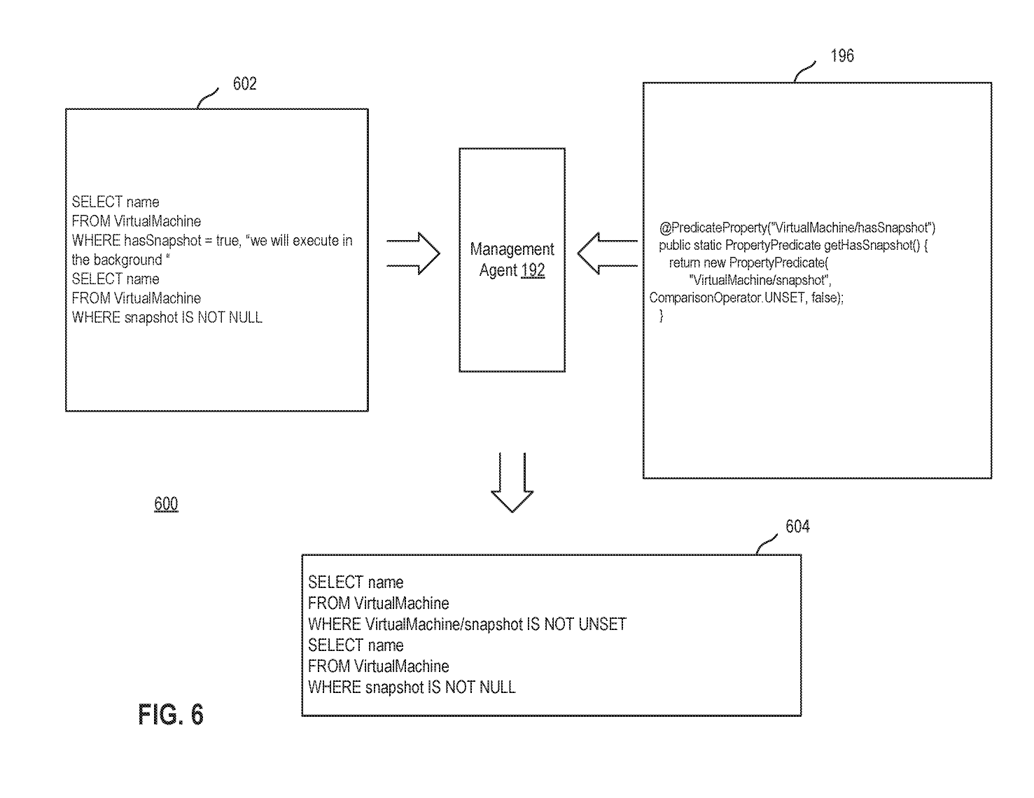

FIG. 6 is a logical flow diagram 600, illustrating an incoming, simple query 602 and an outgoing, modified query 604, according to one embodiment. As shown, positioned between simple query 602 and modified query 604 is management agent 192. The simply query 602 includes the SQL command SELECT. Management agent 192 denormalizes statements in simple query 602 using properties 196 to translate simple query 602 to modified query 604.

The various embodiments described herein may employ various computer-implemented operations involving data stored in computer systems. For example, these operations may require physical manipulation of physical quantities—usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more computer readable media. The term computer readable medium refers to any data storage device that can store data which can thereafter be input to a computer system—computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method of querying a database having information contained therein that is associated with one or more virtual machines executing on a host, comprising:
receiving a query in a first format from a user device, wherein the first format is not executable in the database;
parsing the query to identify one or more commands in the query;
translating the query into a modified query that is executable in the database, comprising:
referencing one or more pre-loaded properties associated with the database;
executing the translated query against the database; and
returning results of the execution.

2. The method of claim 1, wherein receiving a query in a first format from a user device, wherein the first format is not executable in the database, comprises:
receiving a simplified query in a language native to a user.

3. The method of claim 1, wherein parsing the query to identify one or more commands in the query, comprises:
parsing the query to identify one or more commands associated with a structured query language.

4. The method of claim 1, wherein referencing one or more pre-loaded properties associated with the database, comprises:
referencing a related property, which is a client-side query model that is mapped to an existing property value.

5. The method of claim 1, wherein referencing one or more pre-loaded properties associated with the database, comprises:
referencing a derived property, which is computed as a function over existing properties of a given resource property.

6. The method of claim 1, wherein referencing one or more pre-loaded properties associated with the database, comprises:
referencing a predicate property, which is a Boolean-value property.

7. The method of claim 1, referencing one or more pre-loaded properties associated with the database, comprises:
denormalizing statements in the query using the pre-loaded properties to translate the query to a modified query.

8. A non-transitory computer readable medium having instructions stored thereon that when executed by a processor cause the processor to perform a method of querying a database having information contained therein that is associated with one or more virtual machines executing on a host, comprising:
receiving a query in a first format from a user device, wherein the first format is not executable in the database;
parsing the query to identify one or more commands in the query;
translating the query into a modified query that is executable in the database, comprising:
referencing one or more pre-loaded properties associated with the database;
executing the translated query against the database; and
returning results of the execution.

9. The non-transitory computer readable medium of claim 8, wherein receiving a query in a first format from a user device, wherein the first format is not executable in the database, comprises:
receiving a simplified query in a language native to a user.

10. The non-transitory computer readable medium of claim 8, wherein parsing the query to identify one or more commands in the query, comprises:
parsing the query to identify one or more commands associated with a structured query language.

11. The non-transitory computer readable medium of claim 8, wherein referencing one or more pre-loaded properties associated with the database, comprises:
referencing a related property, which is a client-side query model that is mapped to an existing property value.

12. The non-transitory computer readable medium of claim 8, wherein referencing one or more pre-loaded properties associated with the database, comprises:
referencing a derived property, which is computed as a function over existing properties of a given resource property.

13. The non-transitory computer readable medium of claim 8, wherein referencing one or more pre-loaded properties associated with the database, comprises:
referencing a predicate property, which is a Boolean-value property.

14. The non-transitory computer readable medium of claim 8, referencing one or more pre-loaded properties associated with the database, comprises:
denormalizing statements in the query using the pre-loaded properties to translate the query to a modified query.

15. A computer system, comprising:
a processor; and
a memory storing program code, which, when executed on the processor, performs a method of querying a database having information contained therein that is associated with one or more virtual machines executing on a host, comprising:
receiving a query in a first format from a user device, wherein the first format is not executable in the database;
parsing the query to identify one or more commands in the query;
translating the query into a modified query that is executable in the database, comprising:
referencing one or more pre-loaded properties associated with the database;
executing the translated query against the database; and
returning results of the execution.

16. The computer system of claim 15, wherein receiving a query in a first format from a user device, wherein the first format is not executable in the database, comprises:
receiving a simplified query in a language native to a user.

17. The computer system of claim 15, wherein parsing the query to identify one or more commands in the query, comprises:
parsing the query to identify one or more commands associated with a structured query language.

18. The computer system of claim 15, wherein referencing one or more pre-loaded properties associated with the database, comprises:
referencing a related property, which is a client-side query model that is mapped to an existing property value.

19. The computer system of claim 15, wherein referencing one or more pre-loaded properties associated with the database, comprises:
referencing a derived property, which is computed as a function over existing properties of a given resource property.

20. The computer system of claim 15, wherein referencing one or more pre-loaded properties associated with the database, comprises:
referencing a predicate property, which is a Boolean-value property.
